(19) United States
(12) Patent Application Publication
(10) Pub. No.: US 2016/0316456 A1
(43) Pub. Date: Oct. 27, 2016

(54) Radio Access Node, Wireless Device and Methods Performed Therein

(71) Applicant: Telefonaktiebolaget L M Ericsson (publ), Stockholm (SE)

(72) Inventors: Yufei Blankenship, Kildeer, IL (US); Mattias Frenne, Uppsala (SE)

(21) Appl. No.: 14/759,493

(22) PCT Filed: Apr. 10, 2015
(86) PCT No.: PCT/SE2015/000020

§ 371 Date: Jul. 7, 2015

(51) Int. Cl. H04W 72/04

(52) U.S. Cl. CPC H04W 72/042; H04W 72/0446

(57) ABSTRACT

Embodiments herein relate to a method performed in a radio access node (12) for allocating resources of one or more physical downlink control channels for transmission of control information to one or more wireless devices in a wireless communication network (1). The radio access node (12) maps the control information to a sequence of enhanced Control Channel Elements, ECCEs, of the one or more physical downlink control channels in a set of Physical Resource Block, PRB, pairs comprising a number of PRB pairs, wherein each enhanced Control Channel Element, ECCE, in said sequence of ECCEs corresponds to a respective set of enhanced Radio Element Groups, EREGs. The radio access node maps each enhanced Radio Element Group, EREG, in the respective set of EREGs of each ECCE in said sequence of ECCEs to the set of PRB pairs according to a function that distributes each EREG of each ECCE in said sequence of ECCEs among the PRB pairs comprised in the set of PRB pairs to a unique EREG position within the set of PRB pairs, wherein the function distributes the EREGs of two consecutive ECCEs such that an unequal distribution of the EREGs of the two consecutive ECCEs among the PRB pairs comprised in the set of PRB pairs is obtained.

### TECHNICAL FIELD

Embodiments herein relate to a radio access node, a wireless device and methods performed therein. In particular, embodiments herein relate to allocation of resources for control information for the wireless device.

### BACKGROUND

In a typical wireless communication network, wireless devices, also known as wireless communication devices, mobile stations and/or user equipments (UEs), communicate via a Radio Access Network (RAN) to one or more core networks. The RAN covers a geographical area which is divided into cell areas, with each cell area being served by a Base Station (BS), e.g., a radio base station (RBS), which in some networks may also be called, for example, a “NodeB” or “eNodeB”. A cell is a geographical area where radio coverage is provided by the radio base station at a base station site or by an antenna at an antenna site in case the antenna and the radio base station are not collocated. Each cell is identified by an identity within the local radio area, which is broadcast in the cell. Another identity identifying the cell uniquely in the whole wireless communication network is also broadcasted in the cell. One base station may have one or more cells. A cell may be downlink and/or uplink cell, i.e. the cell may be used for communications in the uplink and/or in the downlink. The base stations communicate over the air interface operating on radio frequencies with the user equipments within range of the base stations.

A Universal Mobile Telecommunications System (UMTS) is a third generation wireless communication system, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks and UTRAN specifically, and investigate enhanced data rate and radio capacity. In some RANs, e.g. as in UMTS, several base stations may be connected, e.g., by landlines or microwave, to a controller node, such as a radio network controller (RNC) or a base station controller (BSC), which supervises and coordinates various activities of the plural base stations connected thereto. The RNCs are typically connected to one or more core networks.

Specifications for the Evolved Packet System (EPS) have been completed within the 3rd Generation Partnership Project (3GPP) and this work continues in the coming 3GPP releases. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access technology wherein the radio base station nodes are directly connected to the EPC core network rather than to RNCs. In general, in E-UTRAN/LTE the functions of a RNC are distributed between the radio base stations nodes, e.g. eNodeBs in LTE, and the core network. As such, the Radio Access Network (RAN) of an EPS has an essentially “flat” architecture comprising radio base stations connected directly to one or more core networks, i.e. they are not connected to RNCs.

3GPP Long Term Evolution (LTE) technology is a mobile broadband wireless communication technology in which transmissions from base stations, referred to as eNodeBs or eNBs in LTE, to mobile stations are sent using orthogonal frequency division multiplexing (OFDM). OFDM splits the signal into multiple parallel sub-carriers in frequency. The basic unit of transmission in LTE is a resource block (RB) which in its most common configuration comprises 12 subcarriers and 7 OFDM symbols (one slot). A unit of one subcarrier and 1 OFDM symbol is referred to as a resource element (RE) see FIG. 1. Thus, an RB consists of 84 REs. An LTE radio subframe is composed of multiple resource blocks in frequency, with the number of RBs determining the bandwidth of the system, and two slots in time. Furthermore, the two RBs in a subframe that are adjacent in time are denoted an RB pair.

In the time domain, LTE downlink transmissions are organized into radio frames of 10 ms, each radio frame consisting of ten equally-sized subframes of length T_{subframe}=1 ms. The signal transmitted by the eNB in a downlink subframe may be transmitted from multiple antennas or antenna ports and the signal may be received at a UE that has multiple antennas. The radio channel distorts the transmitted signals from the multiple antenna ports. In order to demodulate any transmissions on the downlink, a UE relies on reference symbols (RS) that are transmitted on the downlink. These reference symbols and their position in the time-frequency grid are known to the UE and hence can be used to determine channel estimates by measuring the effect of the radio channel on these symbols.

Machine-Type Communication (MTC) is an important revenue stream for operators and has a huge potential from the operator perspective. It is efficient for operators to be able to serve MTC UEs using already deployed radio access technology. Therefore 3GPP LTE has been investigated as a competitive radio access technology for efficient support of MTC. Lowering the cost of MTC UE's is an important enabler for implementation of the concept of “internet of things”. For many applications the MTC UE's used will require low operational power consumption and are expected to communicate with infrequent small burst transmissions. In addition, there is a substantial market for the Machine-to-Machine (M2M) use cases of devices deployed deep inside buildings which would require coverage enhancement in comparison to the defined LTE cell coverage footprint.

3GPP LTE Rel-12 has defined UE power saving mode allowing long battery lifetime and a new UE category allowing reduced modem complexity. In Rel-13, further MTC work is expected to further reduce UE cost and provide coverage enhancement. The key element to enable cost reduction is to introduce reduced UE Radio Frequency (RF) bandwidth of 1.4 MHz in downlink and uplink within any system bandwidth. This UE bandwidth corresponds to 6 RB. In this application the RBs may also be denoted Physical Resource Blocks (PRBs), or PRB pairs, acknowledging the fact that time-frequency resources are physical resources. A PRB corresponds to 12 subcarrier and one slot and a PRB pair are two PRBs on the same subcarriers over two slots, which is equal to a subframe.

### Enhanced Control Signaling in LTE

Messages transmitted over the radio link to users can be broadly classified as control messages or data messages. Control messages are used to facilitate the proper operation of the system as well as proper operation of each UE within the system. Control messages could include commands to control functions such as the transmitted power from a UE, signaling of RBs within which the data is to be received by the UE or transmitted from the UE and so on.

In Rel-8, the first one to four OFDM symbols, depending on the configuration, in a subframe are reserved to contain such control information, see FIG. 2. This part of the subframe is denoted control region, whereas the part of the Rel-8 subframe comprising the remaining OFDM symbols is denoted data region.

For normal UEs, i.e. non-MTC UEs, of Rel-11 or later, the UE can be configured to monitor enhanced PDCCH in addition to PDCCH, see TS 36.211 version 11.0.0 and TS 36.213 v. 11.0.0.

The enhanced physical downlink control channel (enhanced PDCCH), also denoted ePDCCH or EPDCCH herein, was thus introduced in Rel-11, in which 2, 4 or 8 Physical Resource Block (PRB) pairs in the data region of the subframe are reserved to exclusively contain enhanced PDCCH transmissions, while excluding from the PRB pairs the one to four first symbols that may contain control information to UEs of releases earlier than Rel-11.

The enhanced PDCCH (EPDCCH) is frequency multiplexed with PDSCH transmissions contrary to PDCCH which is time multiplexed with PDSCH transmissions. This means that some of the PRB pairs of a subframe belong to one or more ePDCCH sets. The remaining PRB pairs can thus be used for PDSCH transmissions. Note also that multiplexing of PDSCH and any enhanced PDCCH transmission within the same PRB pair is not supported in LTE.

Furthermore, two modes of enhanced PDCCH transmission is supported, the localized and the distributed enhanced PDCCH transmission.

In distributed transmission, an enhanced PDCCH is mapped to resource elements within and EPCCH set consisting of D PRB pairs, where D=2, 4, or 8 are the supported number of PRB pairs in an EPDCCH set in LTE. By configuring the D pairs distributed over the system bandwidth, frequency diversity can be achieved for the enhanced PDCCH message. See FIG. 3 for an illustration of the concept of distributed transmission.

FIG. 3 shows a downlink subframe showing 4 parts, or enhanced resource element groups (EREGs), belonging to an enhanced PDCCH being mapped to multiple of the PRB pairs in an enhanced PDCCH set, to achieve distributed transmission and frequency diversity.

In localized transmission, an enhanced PDCCH is mapped to one or two PRB pairs in the EPDCCH set only. For lower aggregation levels only one pair is used. In case the aggregation level of the enhanced PDCCH is too large to fit the enhanced PDCCH in one pair, the second PRB pair is used as well. See FIG. 4 for an illustration of localized transmission. FIG. 4 shows a Downlink subframe showing that for aggregation level 4, the 4 enhanced control channel elements (ECCEs) belonging to an enhanced PDCCH are mapped to one PRB pair in the EPDCCH set, to achieve localized transmission. The aggregation level determines how many ECCE an enhanced EPDCCH comprises. For example, at aggregation level one, each ePDCCH comprises one ECCE. Up to aggregation level 32 is supported for EPDCCH in LTE.

To facilitate the mapping of ECCEs to physical resources, each PRB pair is divided into 16 EREGs and each ECCE is further divided into N_{EREG}^{ECCE}=4 EREGs per ECCE or N_{EREG}^{ECCE}=8 EREGs per ECCE. For normal Cyclic Prefix (CP) and normal subframes, N_{EREG}^{ECCE}=4 unless some conditions are met as described in TS 36.213 v11.0.0. For extended CP and in some special subframes for Frame structure 2 (TDD) N_{EREG}^{ECCE}=8 is used. An enhanced PDCCH is consequently mapped to a multiple of four or eight EREGs wherein the multiple depends on the aggregation level.

These EREGs belonging to an enhanced PDCCH resides in either a single PRB pair, as is typical for localized transmission, or a multiple of PRB pairs, as is typical for distributed transmission. The division of a PRB pair into EREGs is illustrated in FIG. 5.

FIG. 5 shows a PRB pair of normal cyclic prefix configuration in a normal subframe. Dark squares contain the demodulation reference signals (DMRS). Each tile is a resource element in which the number corresponds to the EREG it belongs to. The REs denoted ‘0’ corresponds to the REs belonging to the same EREG, which EREG is indexed with 0, the REs denoted ‘1’ corresponds to the REs belonging to the same EREG, which EREG is indexed with 1 and so on.

### Allocation of Enhanced PDCCH Resources

The enhanced PDCCH resources are wireless device specifically configured in terms of enhanced PDCCH sets Xₘ . An enhanced PDCCH set is a collection of a number, N_{RB}^{X}^{ₘ} or D as denoted above, of PRB pairs containing ECCEs where possible values are N_{RB}^{X}^{ₘ}=2, 4, 8.

For each serving cell, higher layer signalling can configure a wireless device with one or two enhanced PDCCH-PRB-sets Xₘ for enhanced PDCCH monitoring, indexed by m=0 and m=1 respectively. Each enhanced PDCCH-PRB-set is composed of a set of ECCEs numbered from 0 to N_{ECCE,m,k}−1 where N_{ECCE,m,k} is the number of ECCEs in enhanced PDCCH-PRB-set Xₘ of subframe k. Each enhanced PDCCH-PRB-set can be configured for either localized enhanced PDCCH transmission or distributed enhanced PDCCH transmission.

The wireless device shall monitor a set of enhanced PDCCH candidates on one or more activated serving cells as configured by higher layer signalling for control information, where monitoring implies attempting to decode each of the enhanced PDCCHs in the set according to the monitored Downlink Control Information (DCI) formats. For example, if the number N_{RB}^{X}^{ₘ} of PRB pairs is 2 and the number of ECCEs in enhanced PDCCH-PRB-set Xₘ of subframe k is 8, the wireless device will receive 15 enhanced PDCCH candidates: 8 enhanced PDCCH candidates composed of 1 ECCE each, 4 enhanced PDCCH candidates composed of 2 ECCE each, 2 enhanced PDCCH candidates composed of 4 ECCE each and 1 enhanced PDCCH candidate composed of 8 ECCE. These EPDCCH candidates are known as the EPDCCH monitoring set. Exactly which ECCE(s) that correspond to each EPDCCH candidate changes from subframe to subframe and also depends on an identity of the wireless device, e.g. Radio Network Temporary Identifier (RNTI). The relation between and EPDCCH candidate and its ECCEs is given by a search space equation which use the RNTI and subframe number as an input. For EPDCCH, also the EPDCCH set is an input to the search space equation. In summary, the EPDCCH candidates in a subframe are given by the search space.

Moreover, for each candidate in the search space for the wireless device, and in a particular subframe, the wireless device attempts to decode two or three control messages with different payload sizes, known as three different downlink control information (DCI) formats. The first DCI format carries downlink scheduling, the second uplink scheduling. A third DCI format will additionally be decoded for wireless devices that support uplink Multiple Input Multiple Output (MIMO), which is an optional feature. Hence, all LTE wireless devices must monitor, i.e. decode at least two DCI formats for each EPDCCH candidate. In the example above with 15 EPDCCH candidates, a wireless device not supporting uplink MIMO will perform 30 blind decodes, since the wireless device does not know which one of the 30 possible decoding alternatives that contains scheduling information intended for that wireless device, in the subframe based on the 15 EPDCCH candidates.

The set of enhanced PDCCH candidates to monitor are defined in terms of enhanced PDCCH wireless device-specific search spaces.

For each serving cell, the subframes in which the wireless device monitors enhanced PDCCH wireless device-specific search spaces are configured by higher layers, see TS 36.331 v11.0.0.

For example, a wireless device may be configured with K=2 enhanced PDCCH sets Xₙ, and N_{RB}^{X}^{ₘ}=4 and N_{RB}^{X}^{ₘ}=8 and where the first set is used for localized transmission and the second for distributed transmission. The total number of blind decodes, e.g. 32 in the case uplink MIMO is not configured, is split between the K sets. How this split is done is given by table 9.1.4.1b in TS 36.213 v11.0.0. As specified in this table, a wireless device will monitor Bᵢ enhanced PDCCH candidates in enhanced PDCCH set i, where the index i corresponds to index m above and may take values 0 or 1 in this example.

### Mapping of Enhanced PDCCH to RE

Each enhanced PDCCH consists of Aggregation Level (AL) ECCEs where AL is an Aggregation Level of the message. Each ECCE in turn comprises N_{EREG}^{ECCE} EREG where N_{EREG}^{ECCE}=4 or N_{EREG}^{ECCE}=8. In each PRB pair there are always 16 EREG. When enhanced PDCCH collides in mapping with other signals such as own cell Cell specific Reference Signal (CRS) or own cell legacy control region, the other signals have priority and enhanced PDCCH is mapped around these occupied REs and code chain rate matching is applied. This means that the effective number of available RE per EREG is usually less than the 9 RE but there is no interference from these colliding signals introduced in the decoding since the enhanced PDCCH is mapped around those colliding signals.

Within enhanced PDCCH set Xₘ in subframe k, the ECCEs available for transmission of enhanced PDCCHs are numbered from 0 to N_{ECCE,m,k}−1 and ECCE number n corresponds to
EREGs numbered (n mod N_{ECCE}^{RB})+jN_{ECCE}^{RB} in PRB index └n/N_{ECCE}^{RB}┘ for localized mapping, and
EREGs numbered └n/N_{RB}^{X}^{ₘ}┘+jN_{ECCE}^{RB} in PRB indices (n+j max(1,N_{RB}^{X}^{ₘ}/N_{EREG}^{ECCE}))mod N_{RB}^{X}^{ₘ} for distributed mapping,

where j=0, 1, . . . , N_{EREG}^{ECCE}−1, N_{EREG}^{ECCE} is the number of EREGs per ECCE, and N_{ECCE}^{RB}16/N_{EREG}^{ECCE} is the number of ECCEs per resource-block pair, and where k=0, 1, . . . , 9 is a subframe number within a radio frame. The physical resource-block pairs constituting enhanced PDCCH set Xₘ are in this paragraph assumed to be numbered in ascending order from 0 to N_{RB}^{X}^{ₘ}−1.

Problems with Existing Solutions

The current definition of ECCE in the distributed case has a problem with enhanced PDCCH set sizes different from the specified N_{RB}^{X}^{ₘ}=2, 4, or 8, particularly when the set size is not a power of two. The problem for these cases lies in that two different ECCE will map to the same EREG of a PRB pair. This will cause ambiguities at the transmitter as well as the receiver reducing the performance of the wireless communication network. Hence, the current ECCE definition does not work if enhanced PDCCH set Xₘ is composed of N_{RB}^{X}^{ₘ}=6 PRB pairs, which is a problem resulting in a reduced performance of the wireless communication network. There is thus a need of defining ECCE and thus enhanced PDCCH candidates when enhanced PDCCH PRB set Xₘ is composed of at least 6 PRB pairs, as is required e.g. by Rel-13 MTC application.

### SUMMARY

An object of embodiments herein is to provide a mechanism that improves performance of a wireless communication network.

The object is achieved by providing a method performed in a radio access node for allocating resources of one or more physical downlink control channels for transmission of control information to one or more wireless devices in a wireless communication network. The radio access node maps the control information to a sequence of ECCEs of the one or more physical downlink control channels in a set of PRB pairs comprising a number of PRB pairs, wherein each ECCE in said sequence of ECCEs corresponds to a respective set of EREGs. The radio access node maps each EREG in the respective set of EREGs of each ECCE in said sequence of ECCEs to the set of PRB pairs according to a function that distributes each EREG of each ECCE in said sequence of ECCEs among the PRB pairs comprised in the set of PRB pairs to a unique EREG position within the set of PRB pairs. The function distributes the EREGs of two consecutive ECCEs such that an unequal distribution of the EREGs of the two consecutive ECCEs among the PRB pairs comprised in the set of PRB pairs is obtained.

Furthermore, the object is achieved by providing a method performed in a wireless device for enabling receiving control information carried over resources of one or more physical downlink control channels from a radio access node in a wireless communication network. The wireless device attempts to decode the control information for all physical downlink control channel candidates in a monitoring set, according to a monitored downlink control information format. Each physical downlink control channel candidate comprises a sequence of ECCEs of the one or more physical downlink control channels in a set of PRB pairs comprising a number of PRB pairs, wherein each ECCE in said sequence of ECCEs corresponds to a respective set of EREGs. The wireless device further attempts to decode the control information by expecting to find each EREG in the respective set of EREGs of each ECCE in said sequence of ECCEs that are comprised in the set of PRB pairs in an order prescribed by a function that selects each EREG of each ECCE in said sequence of ECCEs among the PRB pairs comprised in the set of PRB pairs at a unique EREG position within the set of PRB pairs. The function selects the EREGs of two consecutive ECCEs assuming an unequal distribution of the EREGs of the two consecutive ECCEs among the PRB pairs comprised in the set of PRB pairs.

The object is further achieved by providing a radio access node for allocating resources of one or more physical downlink control channels for transmission of control information to one or more wireless devices in a wireless communication network. The radio access node is configured to map the control information to a sequence of ECCEs of the one or more physical downlink control channels in a set of Physical Resource Block, PRB, pairs comprising a number of PRB pairs, wherein each ECCE in said sequence of ECCEs corresponds to a respective set of EREGs. The radio access node is further configured to map each EREG in the respective set of EREGs of each ECCE in said sequence of ECCEs to the set of PRB pairs according to a function that distributes each EREG of each ECCE in said sequence of ECCEs among the PRB pairs comprised in the set of PRB pairs to a unique EREG position within the set of PRB pairs. The function distributes the EREGs of two consecutive ECCEs such that an unequal distribution of the EREGs of the two consecutive ECCEs among the PRB pairs comprised in the set of PRB pairs is obtained.

The object is additionally achieved by providing a wireless device for enabling receiving control information carried over resources of one or more physical downlink control channel from the radio access node in the wireless communication network. The wireless device is configured to attempt to decode the control information for all physical downlink control channel candidates in a monitoring set, according to a monitored downlink control information format. Each physical downlink control channel candidate comprises a sequence of ECCEs of the one or more physical downlink control channels in a set of PRB pairs comprising a number of PRB pairs, wherein each ECCE in said sequence of ECCEs corresponds to a respective set of EREGs. The wireless device is further configured to attempt to decode the control information by expecting to find each EREG in the respective set of EREGs of each ECCE in said sequence of ECCEs that are comprised in the set of PRB pairs in an order prescribed by a function that selects each EREG of each ECCE in said sequence of ECCEs among the PRB pairs comprised in the set of PRB pairs at a unique EREG position within the set of PRB pairs. The function selects the EREGs of two consecutive ECCEs assuming an unequal distribution of the EREGs of the two consecutive ECCEs among the PRB pairs comprised in the set of PRB pairs.

The performance of the wireless communication network is improved as the methods allow e.g. a narrow-band MTC device to operate in a legacy LTE system with wider system bandwidth, and be able to obtain configuration of a PDCCH adapted to requirements or needs for the narrow-band operation at the initialization stage.

### BRIEF DESCRIPTION OF THE DRAWINGS

Embodiments will now be described in more detail in relation to the enclosed drawings, in which:

FIG. 1 shows an LTE subframe;

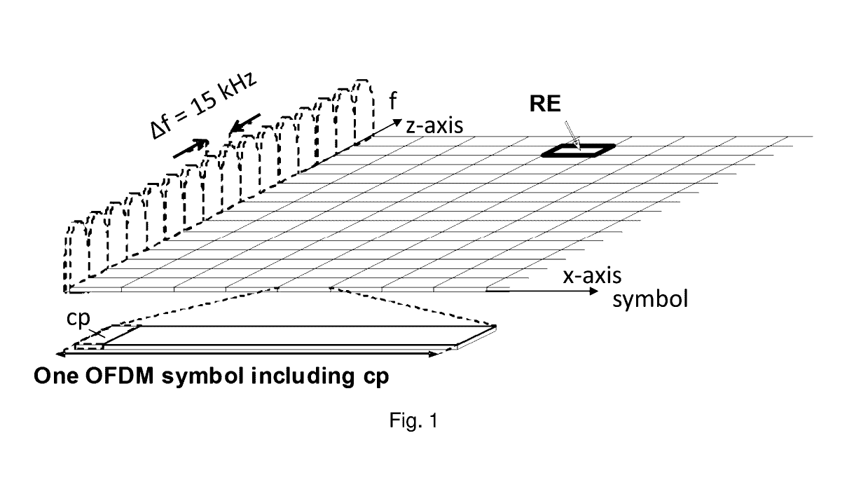

FIG. 2 shows resource elements of a subframe;

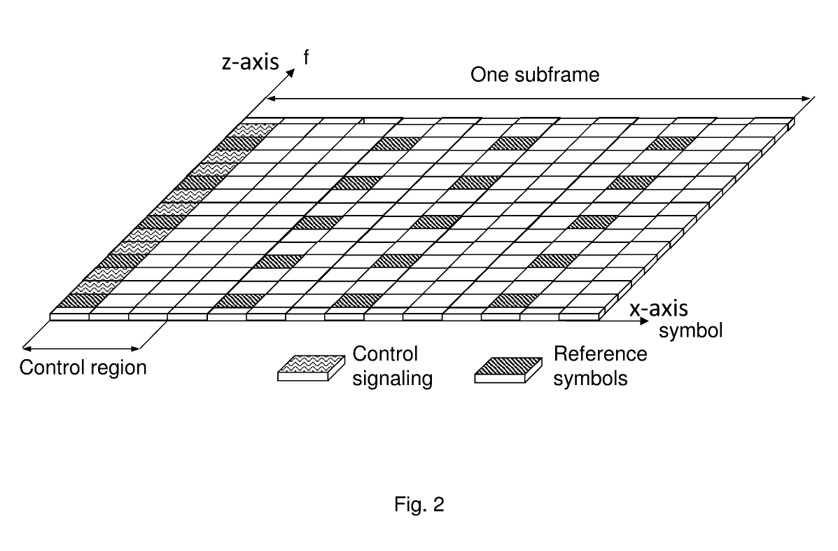

FIG. 3 shows resources of a control channel;

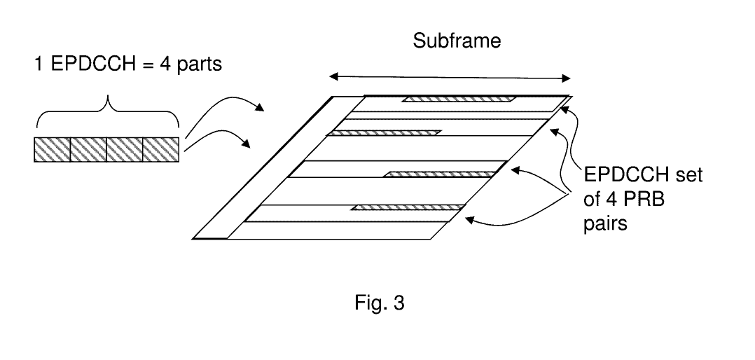

FIG. 4 shows resources of a control channel;

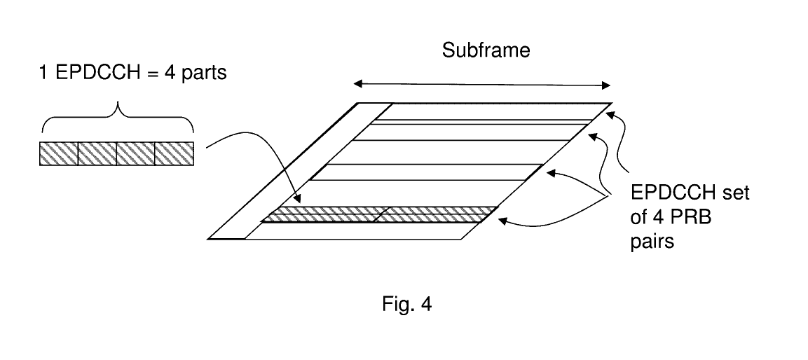

FIG. 5 shows EREGs of a PRB pair;

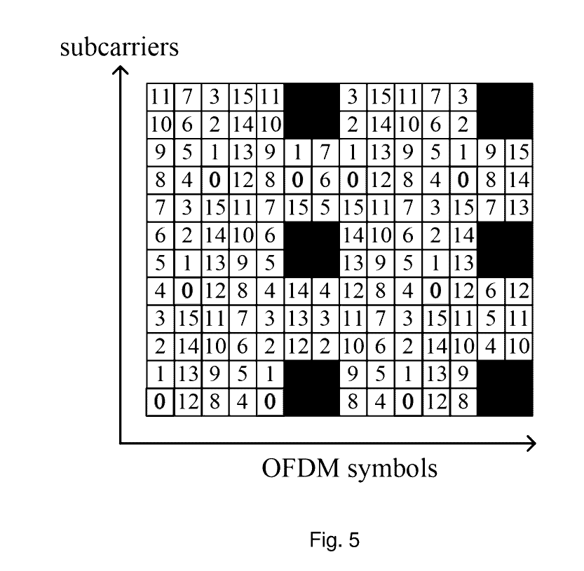

FIG. 6 shows a schematic overview depicting a wireless communication network according to embodiments herein;

FIG. 7 shows a schematic flowchart according to embodiments herein;

FIG. 8 shows a schematic mapping of EREGs to PRB pairs according to embodiments herein;

FIG. 9 shows a schematic mapping of EREGs to PRB pairs according to embodiments herein;

FIG. 10 shows a schematic mapping of EREGs to PRB pairs according to embodiments herein;

FIG. 11 shows a schematic flowchart according to embodiments herein;

FIG. 12 shows a block diagram depicting a radio access node according to embodiments herein; and

FIG. 13 shows a block diagram depicting a wireless device according to embodiments herein.

### DETAILED DESCRIPTION

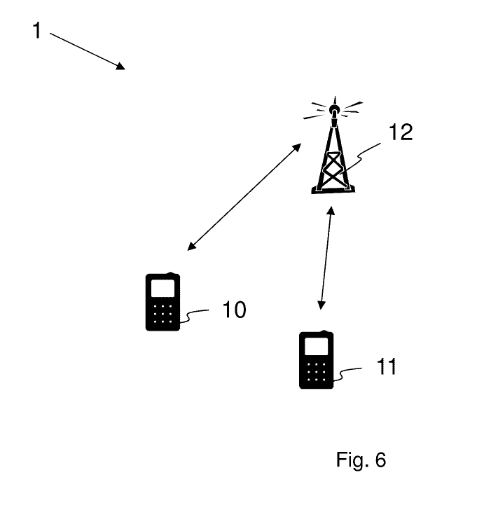

Embodiments herein relate to wireless communication networks in general. FIG. 6 is a schematic overview depicting a wireless communication network 1. The wireless communication network 1 comprises one or more RANs and one or more CNs. The wireless communication network 1 may use a number of different technologies, such as Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. The wireless communication network 1 is exemplified herein as an LTE network.

In the wireless communication network 1, a wireless device 10 or a first wireless device, and a second wireless device 11, such as mobile stations, user equipments and/or wireless terminals, communicate via a Radio Access Network (RAN) to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell. In particular, the wireless device 10 may be a MTC device with a bandwidth allocated to it in a subframe comprising 6 consecutive PRB pairs in downlink within the wireless communication network 1.

The wireless communication network 1 covers a geographical area which is divided into cell areas, e.g. a cell being served by a radio access node 12. The radio access node 12 may also be referred to as a radio base station and e.g. a NodeB, an evolved Node B (eNB, eNode B), a base transceiver station, Access Point Base Station, base station router, access point, Wi-Fi access point, or any other network unit capable of communicating with a wireless device within the cell served by the radio access node 12 depending e.g. on the radio access technology and terminology used. The radio access node 12 may serve one or more cells.

Embodiments herein enable mapping of control information to one or more physical downlink control channels, e.g. an EPDCCH, for e.g. narrow band MTC operation in LTE. Current enhanced PDCCH can be configured to operate in 2, 4 or 8 PRB bandwidths, but MTC operation with low complexity wireless devices use maximum 6 PRB bandwidth, e.g. 3, 5 or 6 RB pairs, allocation. The embodiments herein map sets of EREGs of two consecutive ECCEs in a sequence of ECCEs in the PRB pairs according to a function that distributes each EREG of each ECCE in said sequence of ECCEs among the PRB pairs comprised in the set of PRB pairs to a unique EREG position within the set of PRB pairs. Position means herein a resource element or a group of resource elements of the set of PRB pairs, e.g. respective positions of a group of resource elements comprised in an EREG within the set of PRB pairs. The function distributes the EREGs of two consecutive ECCEs such that an unequal distribution of the EREGs of the two consecutive ECCEs among the PRB pairs comprised in the set of PRB pairs is obtained. Hence, embodiments herein enable utilization of e.g. all 6 PRB pairs for an enhanced PDCCH transmission improving the coverage in the cell and wherein each ECCE uses a unique combination of set of EREGs and PRB pair within the set of PRB pairs that is not colliding or not overlapping with a combination of set of EREGs and PRB pair within the set of PRB pairs of another ECCE. Embodiments herein provide several methods on defining ECCE and search space candidates when e.g. an enhanced PDCCH set Xₘ is composed of N_{RB}^{X}^{ₘ} PRB pairs, where N_{RB}^{X}^{ₘ} is not a power of two, for instance 6 as is required by MTC application of Release 13.

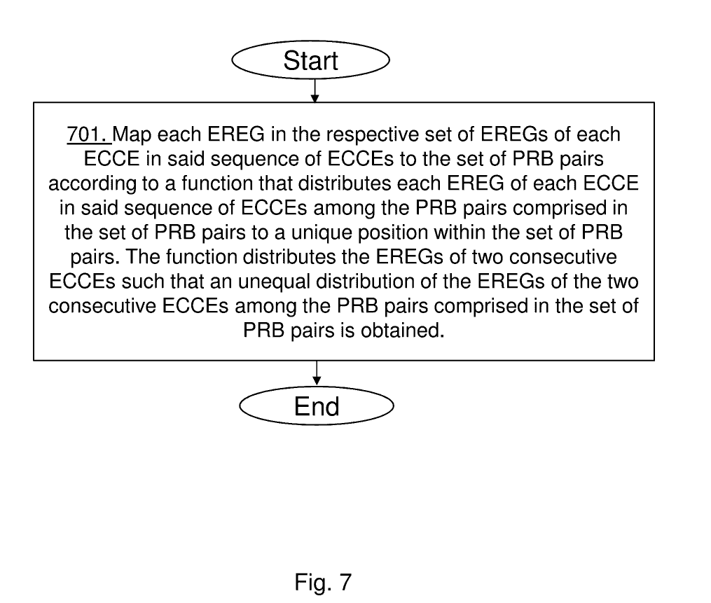

The method actions in the radio access node 12 for allocating resources of one or more physical downlink control channels for transmission of control information to one or more wireless devices, such as the first wireless device 10 and the second device 11, in the wireless communication network according to some embodiments will now be described with reference to a flowchart depicted in FIG. 7.

Action 701. The radio access node 12 maps the control information to a sequence of ECCEs of the one or more physical downlink control channels in a set of PRB pairs comprising a number of PRB pairs. Each ECCE in said sequence of ECCEs corresponds to a respective set of EREGs. The radio access node maps each EREG in the respective set of EREGs of each ECCE in said sequence of ECCEs to the set of PRB pairs according to a function that distributes each EREG of each ECCE in said sequence of ECCEs among the PRB pairs comprised in the set of PRB pairs to a unique EREG position, e.g. a unique time-frequency resource element or a unique set of time-frequency resource elements, within the set of PRB pairs. The function distributes the EREGs of two consecutive ECCEs such that an unequal distribution of the EREGs of the two consecutive ECCEs among the PRB pairs comprised in the set of PRB pairs is obtained. Thus, the radio access node 12 maps the sets of EREGs of two consecutive ECCEs in said sequence of ECCEs to the set of PRB pairs according to the function that distributes the EREGs of the two ECCEs such that an unequal or a non-uniform distribution of EREGs among the PRB pairs comprised in the set of PRB pairs is obtained. Each respective set of EREGs may comprise a number of EREGs that differs from being the same or an integer multiple of the number of PRB pairs of the set of PRBs and vice versa. That is, the number of PRB pairs of the set of PRBs differs from being the same or an integer multiple of the number of EREGs of each respective set of EREGs. Each ECCE of the sequence of ECCEs uses a unique set of EREGs of the PRB pairs. Hence, each ECCE uses a unique set of resource elements of the PRB pairs.

The radio access node 12 may map the EREGs of the two consecutive ECCEs to PRB pairs in the set of PRB pairs taken in a cyclic order, whereby the EREGs of one of the two consecutive ECCEs are mapped, in e.g. consecutive order, starting from a first PRB pair and the EREGs of the other one of the two consecutive ECCEs are mapped, e.g. in consecutive order, starting from a next PRB pair in the cyclic order of PRB pairs in the set of PRB pairs. The radio access node 12 may thus map an initial EREG of a first ECCE to a first PRB pair and mapping an initial EREG of a second ECCE to a different PRB pair. The PRB pair different from the first PRB pair may or may not be contiguous to the first PRB pair. The radio access node may thus map the EREGs of the ECCEs in said sequence of ECCEs to PRB pairs in the set of PRB pairs taken in a cyclic order, whereby EREGs of the respective set of EREGs of a first ECCE are mapped, e.g. in consecutive order, starting from a first PRB pair and EREGs of the respective set of EREGs of a next ECCE are mapped, e.g. in consecutive order, starting from a next PRB pair in the cyclic order of PRB pairs in the set of PRB pairs. The number of PRB pairs of the set of PRB pairs may be 3, 5, or 6.

The radio access node 12 may map each EREG of each ECCE in said sequence of ECCEs to a respective PRB pair corresponding to a respective PRB index, each respective PRB index being derived using a floor function and/or a ceil function of the number of PRB pairs in the set of PRB pairs divided by the number of EREGs comprised in each respective set of EREGs. Thus, the radio access node 12 may map an EREG of an ECCE to a PRB pair corresponding to a PRB index, which PRB index is derived with the function being a floor function and/or a ceil function based on a quotient between the number of the PRB pairs and the number of EREGs. The quotient may differ from being an integer and differ from the value 0.5.

The floor function may be used in determining each respective PRB index according to

$$( n + j max ( 1 , ⌊ {N}_{RB}^{{X}_{m}} / {N}_{EREG}^{ECCE} ⌋ ) ) mod {N}_{RB}^{{X}_{m}} ,$$

wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

The cell function may be used in determining each respective PRB index according to

$$( n + j max ( 1 , ⌈ {N}_{RB}^{{X}_{m}} / {N}_{EREG}^{ECCE} ⌉ ) ) mod {N}_{RB}^{{X}_{m}} ,$$

using notations as specified above.

The function may further distribute EREGs of all ECCEs of the sequence of ECCE, or a number of ECCEs being an integer multiple of the number of PRB pairs, such that an equal and non-overlapping distribution of EREGs among the number PRB pairs comprised in the set of PRB pairs is obtained.

A bandwidth allocated for the one or more wireless devices in a subframe may comprise 6 consecutive PRBs in downlink within the wireless communication network 1.

The radio access node 12 may further map EREGs of a first ECCE to the set of PRB pairs such that the number of EREGs mapped to at least one PRB pair is different from the number of EREGs mapped to another PRB pair. The radio access node may further map EREGs of a second ECCE in said sequence of ECCEs only when the number of EREGs mapped to at least one PRB pair is different from the number of EREGs mapped to another PRB pair.

Examples herein relate for distributed mapping of the EREGs of ECCEs to the number of PRB pairs. Aggregation level, L, is how many ECCEs are grouped together for one PDCCH and the wireless device 10 and the second wireless device 11 may use different values of L and still coexist in the same set of PRBs. For example, wireless device 10 may use L=1 while the second wireless device 11 may use L=4.

The function may in some embodiments distribute, for each ECCE in said sequence of ECCEs, the EREGs of the respective set of EREGs starting from a PRB pair in said set of PRB pairs that consecutively follows a previous PRB pair. Each ECCE then follows a respective previous ECCE for which the corresponding set of EREGs may be mapped starting from the previous PRB pair in said set of PRB pairs. The PRB pairs in the set of PRB pairs may be cyclically ordered such that a last PRB pair is the previous PRB pair for a first PRB pair in the set of PRB pairs.

The radio access node 12 may in some embodiments map the EREGs of an ECCE such that a first number of EREGs of the ECCE are mapped to a first PRB pair and a second number of EREGs of the ECCE are mapped to a second PRB pair, wherein the first number of EREGs differ from the second number of EREGs. The first number of EREGs may be one and second number of EREGs may be two, or the first number of EREGs may be one and the second number of EREGs may be zero.

In the following, the PDCCH may be exemplified as an enhanced PDCCH e.g. a Low Complex (LC) PDCCH referring to the enhanced physical downlink control channel defined to support the reduced bandwidth low-complexity wireless devices. Note that while the low-complexity wireless device such as a MTC device is used as an example, design of this PDCCH may be utilized by other types of wireless devices as well. LC-PDCCH can be introduced as a new physical downlink control channel or as a new form of enhanced PDCCH.

According to embodiments herein for distributed mapping, the existing ECCE definition, which is ECCE number n corresponds to EREGs numbered └n/N_{RB}^{X}^{ₘ}┘+jN_{ECCE}^{RB} in PRB indices (n+j max(1, N_{RB}^{X}^{ₘ}/N_{EREG}^{ECCE}))mod N_{RB}^{X}^{ₘ} for distributed mapping, may be modified for one or more PDCCHs in either of two non-trivial ways:

According to a first alternative, it may be modified by adding a floor(.) function to define PRB indices. For example, the function that distributes each EREG of each ECCE in said sequence of ECCEs among the PRB pairs comprised in the set of PRB pairs to the unique EREG position within the set of PRB pairs comprises a PRB index determined according to the expression, that is, the PRB indices may be derived with the expression

$$( n + j max ( 1 , ⌊ {N}_{RB}^{{X}_{m}} / {N}_{EREG}^{ECCE} ⌋ ) ) mod {N}_{RB}^{{X}_{m}} ;$$

According to a second alternative, it may be modified by adding a ceil(.) function to define PRB indices. For example, the function that distributes each EREG of each ECCE in said sequence of ECCEs among the PRB pairs comprised in the set of PRB pairs to the unique EREG position within the set of PRB pairs comprises a PRB index determined according to the expression, that is, the PRB indices may be derived with the expression

$$( n + j max ( 1 , ⌈ {N}_{RB}^{{X}_{m}} / {N}_{EREG}^{ECCE} ⌉ ) ) mod {N}_{RB}^{{X}_{m}} .$$

The ECCE mapping to EREGs using the floor function is tabulated in detail in Table 1 for the example of the number of PRB pairs of each set of PRB pairs, N_{RB}^{X}^{ₘ}, =6 and the number of EREGs of each ECCE, N_{EREG}^{ECCE}, =4, and in Table 3 for N_{RB}^{X}^{ₘ}=6 and N_{EREG}^{ECCE}=8.

The ECCE mapping to EREGs using the ceil function is tabulated in detail in Table 2 for the example of N_{RB}^{X}^{ₘ}=6 and N_{EREG}^{ECCE}=4, and in Table 3 for N_{RB}^{X}^{ₘ}=6 and N_{EREG}^{ECCE}=8. The floor and ceiling functions map a real number to a largest previous or a smallest following integer, respectively. More precisely, floor(x)=└χ┘ is the largest integer not greater than x and ceiling(x)=┌χ┐ is the smallest integer not less than x.

TABLE 1
ECCE mapping using floor(.) function for N_{RB}^{X}^{ₘ} = 6
when an ECCE is composed of 4 EREGs

| | | |
|---|---|---|
| ECCE | | |
| index | PRB indices | EREG indices |

| | | | | | | | | |
|---|---|---|---|---|---|---|---|---|
| 0 | 0 | 1 | 2 | 3 | 0 | 4 | 8 | 12 |
| 1 | 1 | 2 | 3 | 4 | 0 | 4 | 8 | 12 |
| 2 | 2 | 3 | 4 | 5 | 0 | 4 | 8 | 12 |
| 3 | 3 | 4 | 5 | 0 | 0 | 4 | 8 | 12 |
| 4 | 4 | 5 | 0 | 1 | 0 | 4 | 8 | 12 |
| 5 | 5 | 0 | 1 | 2 | 0 | 4 | 8 | 12 |
| 6 | 0 | 1 | 2 | 3 | 1 | 5 | 9 | 13 |
| 7 | 1 | 2 | 3 | 4 | 1 | 5 | 9 | 13 |
| 8 | 2 | 3 | 4 | 5 | 1 | 5 | 9 | 13 |
| 9 | 3 | 4 | 5 | 0 | 1 | 5 | 9 | 13 |
| 10 | 4 | 5 | 0 | 1 | 1 | 5 | 9 | 13 |
| 11 | 5 | 0 | 1 | 2 | 1 | 5 | 9 | 13 |
| 12 | 0 | 1 | 2 | 3 | 2 | 6 | 10 | 14 |
| 13 | 1 | 2 | 3 | 4 | 2 | 6 | 10 | 14 |
| 14 | 2 | 3 | 4 | 5 | 2 | 6 | 10 | 14 |
| 15 | 3 | 4 | 5 | 0 | 2 | 6 | 10 | 14 |
| 16 | 4 | 5 | 0 | 1 | 2 | 6 | 10 | 14 |
| 17 | 5 | 0 | 1 | 2 | 2 | 6 | 10 | 14 |
| 18 | 0 | 1 | 2 | 3 | 3 | 7 | 11 | 15 |
| 19 | 1 | 2 | 3 | 4 | 3 | 7 | 11 | 15 |
| 20 | 2 | 3 | 4 | 5 | 3 | 7 | 11 | 15 |
| 21 | 3 | 4 | 5 | 0 | 3 | 7 | 11 | 15 |
| 22 | 4 | 5 | 0 | 1 | 3 | 7 | 11 | 15 |
| 23 | 5 | 0 | 1 | 2 | 3 | 7 | 11 | 15 |

TABLE 2
ECCE mapping using ceil(.) function for
N_{RB}^{X}^{ₘ} = 6 when an ECCE is composed of 4 EREGs.

| | | |
|---|---|---|
| ECCE | | |
| index | PRB indices | EREG indices |

| | | | | | | | | |
|---|---|---|---|---|---|---|---|---|
| 0 | 0 | 2 | 4 | 0 | 0 | 4 | 8 | 12 |
| 1 | 1 | 3 | 5 | 1 | 0 | 4 | 8 | 12 |
| 2 | 2 | 4 | 0 | 2 | 0 | 4 | 8 | 12 |
| 3 | 3 | 5 | 1 | 3 | 0 | 4 | 8 | 12 |
| 4 | 4 | 0 | 2 | 4 | 0 | 4 | 8 | 12 |
| 5 | 5 | 1 | 3 | 5 | 0 | 4 | 8 | 12 |
| 6 | 0 | 2 | 4 | 0 | 1 | 5 | 9 | 13 |
| 7 | 1 | 3 | 5 | 1 | 1 | 5 | 9 | 13 |
| 8 | 2 | 4 | 0 | 2 | 1 | 5 | 9 | 13 |
| 9 | 3 | 5 | 1 | 3 | 1 | 5 | 9 | 13 |
| 10 | 4 | 0 | 2 | 4 | 1 | 5 | 9 | 13 |
| 11 | 5 | 1 | 3 | 5 | 1 | 5 | 9 | 13 |
| 12 | 0 | 2 | 4 | 0 | 2 | 6 | 10 | 14 |
| 13 | 1 | 3 | 5 | 1 | 2 | 6 | 10 | 14 |
| 14 | 2 | 4 | 0 | 2 | 2 | 6 | 10 | 14 |
| 15 | 3 | 5 | 1 | 3 | 2 | 6 | 10 | 14 |
| 16 | 4 | 0 | 2 | 4 | 2 | 6 | 10 | 14 |
| 17 | 5 | 1 | 3 | 5 | 2 | 6 | 10 | 14 |
| 18 | 0 | 2 | 4 | 0 | 3 | 7 | 11 | 15 |
| 19 | 1 | 3 | 5 | 1 | 3 | 7 | 11 | 15 |
| 20 | 2 | 4 | 0 | 2 | 3 | 7 | 11 | 15 |
| 21 | 3 | 5 | 1 | 3 | 3 | 7 | 11 | 15 |
| 22 | 4 | 0 | 2 | 4 | 3 | 7 | 11 | 15 |
| 23 | 5 | 1 | 3 | 5 | 3 | 7 | 11 | 15 |

TABLE 3
ECCE mapping using either floor(.) or ceil(.) function for
N_{RB}^{X}^{ₘ} = 6 when an ECCE is composed of 8 EREGs.

| ECCE | | | | | | | | | | | | | | | | |
|---|---|---|---|---|---|---|---|---|---|---|---|---|---|---|---|---|
| index | PRB indices | | | | | | | | EREG indices | | | | | | | |
| 0 | 0 | 1 | 2 | 3 | 4 | 5 | 0 | 1 | 0 | 2 | 4 | 6 | 8 | 10 | 12 | 14 |
| 1 | 1 | 2 | 3 | 4 | 5 | 0 | 1 | 2 | 0 | 2 | 4 | 6 | 8 | 10 | 12 | 14 |
| 2 | 2 | 3 | 4 | 5 | 0 | 1 | 2 | 3 | 0 | 2 | 4 | 6 | 8 | 10 | 12 | 14 |
| 3 | 3 | 4 | 5 | 0 | 1 | 2 | 3 | 4 | 0 | 2 | 4 | 6 | 8 | 10 | 12 | 14 |
| 4 | 4 | 5 | 0 | 1 | 2 | 3 | 4 | 5 | 0 | 2 | 4 | 6 | 8 | 10 | 12 | 14 |
| 5 | 5 | 0 | 1 | 2 | 3 | 4 | 5 | 0 | 0 | 2 | 4 | 6 | 8 | 10 | 12 | 14 |
| 6 | 0 | 1 | 2 | 3 | 4 | 5 | 0 | 1 | 1 | 3 | 5 | 7 | 9 | 11 | 13 | 15 |
| 7 | 1 | 2 | 3 | 4 | 5 | 0 | 1 | 2 | 1 | 3 | 5 | 7 | 9 | 11 | 13 | 15 |
| 8 | 2 | 3 | 4 | 5 | 0 | 1 | 2 | 3 | 1 | 3 | 5 | 7 | 9 | 11 | 13 | 15 |
| 9 | 3 | 4 | 5 | 0 | 1 | 2 | 3 | 4 | 1 | 3 | 5 | 7 | 9 | 11 | 13 | 15 |
| 10 | 4 | 5 | 0 | 1 | 2 | 3 | 4 | 5 | 1 | 3 | 5 | 7 | 9 | 11 | 13 | 15 |
| 11 | 5 | 0 | 1 | 2 | 3 | 4 | 5 | 0 | 1 | 3 | 5 | 7 | 9 | 11 | 13 | 15 |

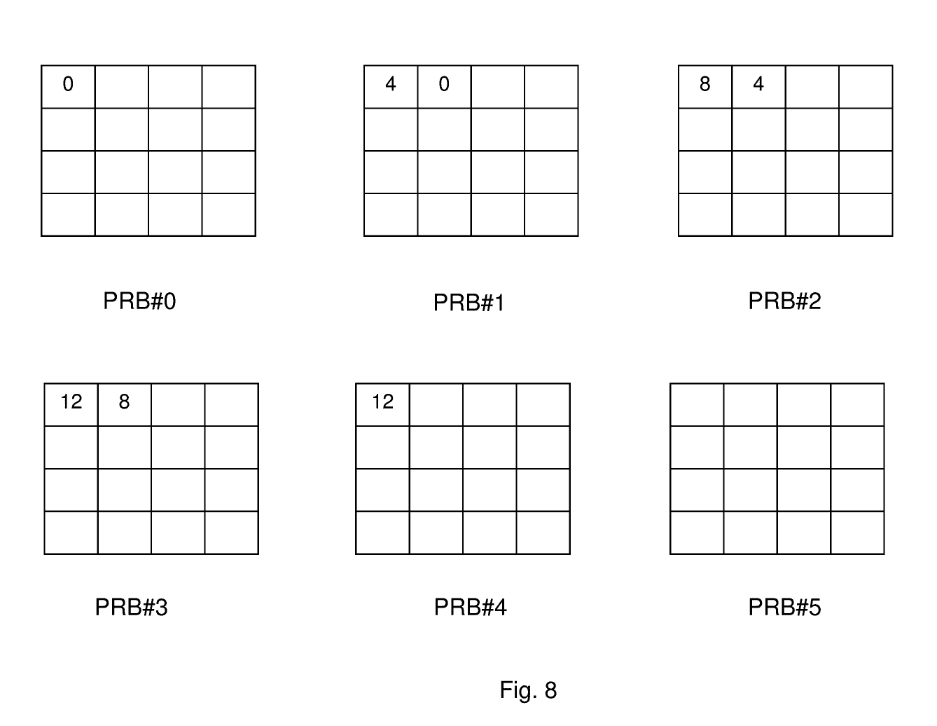

FIG. 8 shows an example mapping EREGs of the first ECCE and the second ECCE according to table 1, wherein EREGs with indices or numbers 0, 4, 8 and 12 are used. The function distributes the EREGs of two consecutive ECCEs such that an unequal distribution of the EREGs of the two consecutive ECCEs among the PRB pairs comprised in the set of PRB pairs is obtained. That is, in the first and fifth PRB pair one EREG is mapped to the respective PRB pair and in the second third and fourth PRB pair two EREGs are mapped to the respective PRB pair. No EREG is mapped to the sixth PRB pair.

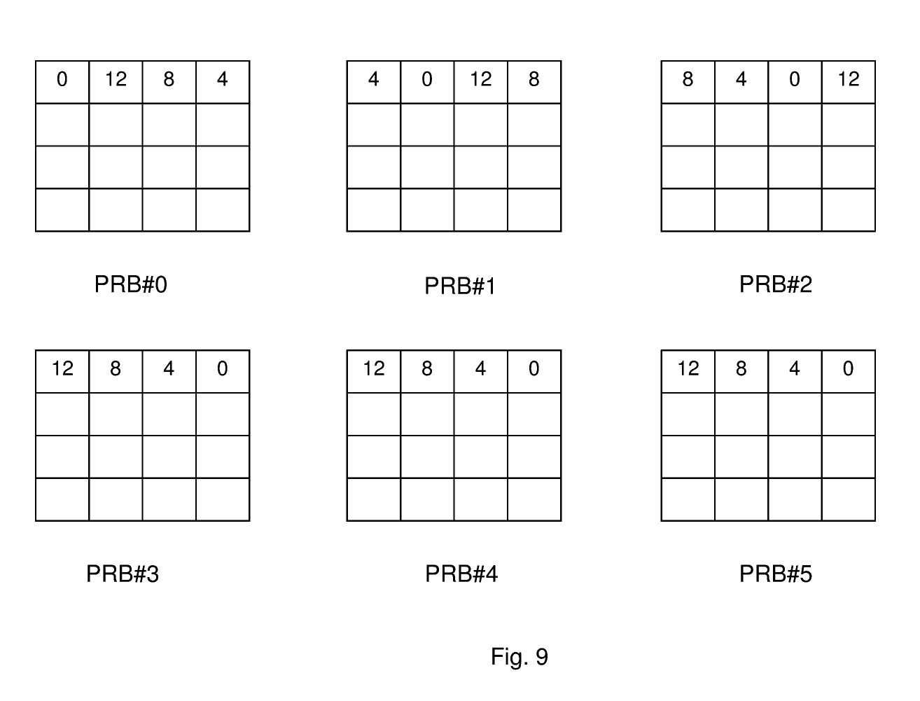

FIG. 9 shows an example of mapping EREGs of a number of ECCEs, i.e. 6 ECCEs, to PRB pairs according to table 1 based on the floor function. The number of ECCEs are a multiple of the number of PRB pairs, in the example the multiple is one, i.e. the number of ECCEs is equal to the number of PRB pairs. The function distributes the EREGs such that an equal distribution of EREGs among the number PRB pairs comprised in the set of PRB pairs is obtained. That is, all PRB pairs comprise the same number of EREGs.

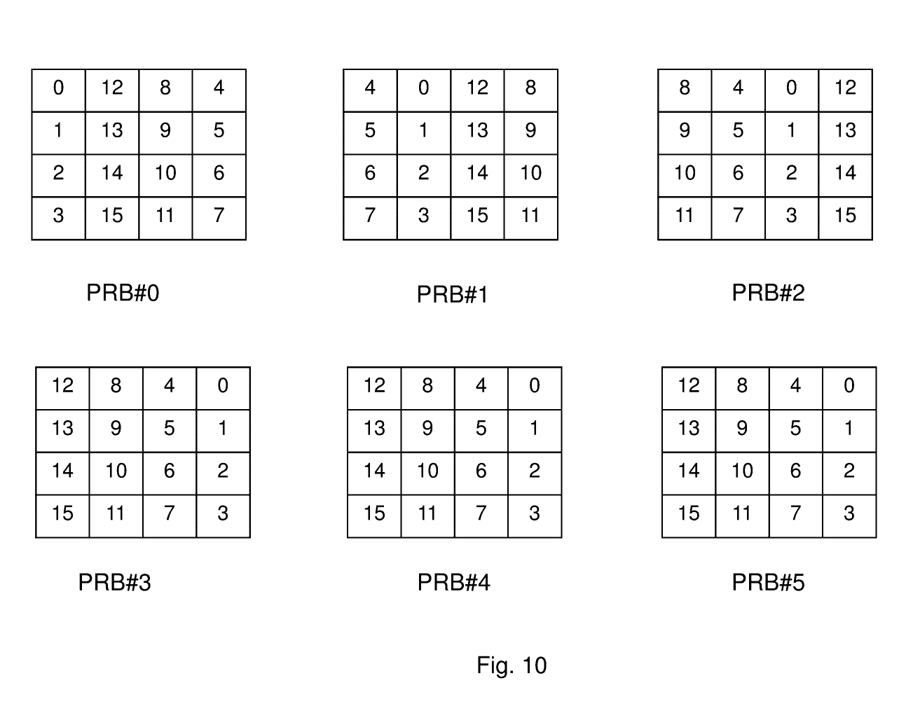

FIG. 10 shows an example of mapping EREGs of all ECCEs, i.e. 24 ECCEs, to 6 PRB pairs according to table 1 based on the floor function. The number of ECCEs whose EREGs are mapped is a multiple of the number of PRB pairs, in the example the multiple is four, and each ECCE comprises 4 EREGs. The function distributes the EREGs such that an equal distribution of EREGs among the 6 PRB pairs is obtained. That is, all PRB pairs comprise the same number of EREGs and the EREGs of all ECCEs are mapped to unique EREG positions of the PRB pairs and do not overlap. In other words, embodiments herein map the EREGs of each ECCE to the PRB pairs in a way that maps all EREGs of all ECCEs to a unique combination of EREG and PRB pair in the PRB pairs.

Embodiments herein avoid the EREG collision problem between two ECCEs also for N_{RB}^{X}^{ₘ}=3, which may also be used for LC-PDCCH. For example, each enhanced PDCCH set may span 3 PRB pairs and the remaining 3 PRB pairs may be used for another enhanced PDCCH set of the same or a different wireless device. Alternatively, the remaining 3 PRB pairs can be used for PDSCH transmission.

Using the floor or ceil function, which gives the same results, the ECCE mapping to EREGs is tabulated in detail in Table 4 for the example of N_{RB}^{X}^{ₘ}=3 and N_{EREG}^{ECCE}=4. The ECCE mapping to EREGs is tabulated in detail in Table 5 for N_{RB}^{X}^{ₙ}=3 and N_{EREG}^{ECCE}=8.

TABLE 4
ECCE mapping using floor(.) function for
N_{RB}^{X}^{ₘ} = 3 when an ECCE is composed of 4 EREGs

| | | |
|---|---|---|
| ECCE | | |
| index | PRB indices | EREG indices |

| | | | | | | | | |
|---|---|---|---|---|---|---|---|---|
| 0 | 0 | 1 | 2 | 0 | 0 | 4 | 8 | 12 |
| 1 | 1 | 2 | 0 | 1 | 0 | 4 | 8 | 12 |
| 2 | 2 | 0 | 1 | 2 | 0 | 4 | 8 | 12 |
| 3 | 0 | 1 | 2 | 0 | 1 | 5 | 9 | 13 |
| 4 | 1 | 2 | 0 | 1 | 1 | 5 | 9 | 13 |
| 5 | 2 | 0 | 1 | 2 | 1 | 5 | 9 | 13 |
| 6 | 0 | 1 | 2 | 0 | 2 | 6 | 10 | 14 |
| 7 | 1 | 2 | 0 | 1 | 2 | 6 | 10 | 14 |
| 8 | 2 | 0 | 1 | 2 | 2 | 6 | 10 | 14 |
| 9 | 0 | 1 | 2 | 0 | 3 | 7 | 11 | 15 |
| 10 | 1 | 2 | 0 | 1 | 3 | 7 | 11 | 15 |
| 11 | 2 | 0 | 1 | 2 | 3 | 7 | 11 | 15 |

TABLE 5
ECCE mapping using floor(.) or ceil(.) function for
N_{RB}^{X}^{ₘ} = 3 when an ECCE is composed of 8 EREGs.

| ECCE | | | | | | | | | | | | | | | | |
|---|---|---|---|---|---|---|---|---|---|---|---|---|---|---|---|---|
| index | PRB indices | | | | | | | | EREG indices | | | | | | | |
| 0 | 0 | 1 | 2 | 0 | 1 | 2 | 0 | 1 | 0 | 2 | 4 | 6 | 8 | 10 | 12 | 14 |
| 1 | 1 | 2 | 0 | 1 | 2 | 0 | 1 | 2 | 0 | 2 | 4 | 6 | 8 | 10 | 12 | 14 |
| 2 | 2 | 0 | 1 | 2 | 0 | 1 | 2 | 0 | 0 | 2 | 4 | 6 | 8 | 10 | 12 | 14 |
| 3 | 0 | 1 | 2 | 0 | 1 | 2 | 0 | 1 | 1 | 3 | 5 | 7 | 9 | 11 | 13 | 15 |
| 4 | 1 | 2 | 0 | 1 | 2 | 0 | 1 | 2 | 1 | 3 | 5 | 7 | 9 | 11 | 13 | 15 |
| 5 | 2 | 0 | 1 | 2 | 0 | 1 | 2 | 0 | 1 | 3 | 5 | 7 | 9 | 11 | 13 | 15 |

Embodiments avoid the EREG collision problem between two ECCEs also for N_{RB}^{X}^{ₘ}=5, which may also be used for PDCCH. For example, each enhanced PDCCH set may span 5 PRB pairs and the remaining 1 PRB pairs may be used for another enhanced PDCCH set or used for PDSCH transmission.

Using the floor function, the ECCE mapping to EREGs is tabulated in details in Table 6 for the example of N_{RB}^{X}^{ₘ}=5 and N_{EREG}^{ECCE}=4, and in Table 8 for N_{RB}^{X}^{ₘ}=5 and N_{EREG}^{ECCE}=8.

Using the cell function, the ECCE mapping to EREGs is tabulated in details in Table 7 for the example of N_{RB}^{X}^{ₘ}=5 and N_{EREG}^{ECCE}=4, and in Table 8 for N_{RB}^{X}^{ₘ}=5 and N_{EREG}^{ECCE}=8.

TABLE 6
ECCE mapping using floor(.) function for
N_{RB}^{X}^{ₘ} = 5 when an ECCE is composed of 4 EREGs

| | | |
|---|---|---|
| ECCE | | |
| index | PRB indices | EREG indices |

| | | | | | | | | |
|---|---|---|---|---|---|---|---|---|
| 0 | 0 | 1 | 2 | 3 | 0 | 4 | 8 | 12 |
| 1 | 1 | 2 | 3 | 4 | 0 | 4 | 8 | 12 |
| 2 | 2 | 3 | 4 | 0 | 0 | 4 | 8 | 12 |
| 3 | 3 | 4 | 0 | 1 | 0 | 4 | 8 | 12 |
| 4 | 4 | 0 | 1 | 2 | 0 | 4 | 8 | 12 |
| 5 | 0 | 1 | 2 | 3 | 1 | 5 | 9 | 13 |
| 6 | 1 | 2 | 3 | 4 | 1 | 5 | 9 | 13 |
| 7 | 2 | 3 | 4 | 0 | 1 | 5 | 9 | 13 |
| 8 | 3 | 4 | 0 | 1 | 1 | 5 | 9 | 13 |
| 9 | 4 | 0 | 1 | 2 | 1 | 5 | 9 | 13 |
| 10 | 0 | 1 | 2 | 3 | 2 | 6 | 10 | 14 |
| 11 | 1 | 2 | 3 | 4 | 2 | 6 | 10 | 14 |
| 12 | 2 | 3 | 4 | 0 | 2 | 6 | 10 | 14 |
| 13 | 3 | 4 | 0 | 1 | 2 | 6 | 10 | 14 |
| 14 | 4 | 0 | 1 | 2 | 2 | 6 | 10 | 14 |
| 15 | 0 | 1 | 2 | 3 | 3 | 7 | 11 | 15 |
| 16 | 1 | 2 | 3 | 4 | 3 | 7 | 11 | 15 |
| 17 | 2 | 3 | 4 | 0 | 3 | 7 | 11 | 15 |
| 18 | 3 | 4 | 0 | 1 | 3 | 7 | 11 | 15 |
| 19 | 4 | 0 | 1 | 2 | 3 | 7 | 11 | 15 |

TABLE 7
ECCE mapping using ceil(.) function for
N_{RB}^{X}^{ₘ} = 5 when an ECCE is composed of 4 EREGs.

| | | |
|---|---|---|
| ECCE | | |
| index | PRB indices | EREG indices |

| | | | | | | | | |
|---|---|---|---|---|---|---|---|---|
| 0 | 0 | 2 | 4 | 1 | 0 | 4 | 8 | 12 |
| 1 | 1 | 3 | 0 | 2 | 0 | 4 | 8 | 12 |
| 2 | 2 | 4 | 1 | 3 | 0 | 4 | 8 | 12 |
| 3 | 3 | 0 | 2 | 4 | 0 | 4 | 8 | 12 |
| 4 | 4 | 1 | 3 | 0 | 0 | 4 | 8 | 12 |
| 5 | 0 | 2 | 4 | 1 | 1 | 5 | 9 | 13 |
| 6 | 1 | 3 | 0 | 2 | 1 | 5 | 9 | 13 |
| 7 | 2 | 4 | 1 | 3 | 1 | 5 | 9 | 13 |
| 8 | 3 | 0 | 2 | 4 | 1 | 5 | 9 | 13 |
| 9 | 4 | 1 | 3 | 0 | 1 | 5 | 9 | 13 |
| 10 | 0 | 2 | 4 | 1 | 2 | 6 | 10 | 14 |
| 11 | 1 | 3 | 0 | 2 | 2 | 6 | 10 | 14 |
| 12 | 2 | 4 | 1 | 3 | 2 | 6 | 10 | 14 |
| 13 | 3 | 0 | 2 | 4 | 2 | 6 | 10 | 14 |
| 14 | 4 | 1 | 3 | 0 | 2 | 6 | 10 | 14 |
| 15 | 0 | 2 | 4 | 1 | 3 | 7 | 11 | 15 |
| 16 | 1 | 3 | 0 | 2 | 3 | 7 | 11 | 15 |
| 17 | 2 | 4 | 1 | 3 | 3 | 7 | 11 | 15 |
| 18 | 3 | 0 | 2 | 4 | 3 | 7 | 11 | 15 |
| 19 | 4 | 1 | 3 | 0 | 3 | 7 | 11 | 15 |

TABLE 8
ECCE mapping using either floor(.) or ceil(.) function
for N_{RB}^{X}^{ₘ} = 5 when an ECCE is composed of 8 EREGs

| ECCE | | | | | | | | | | | | | | | | |
|---|---|---|---|---|---|---|---|---|---|---|---|---|---|---|---|---|
| index | PRB indices | | | | | | | | EREG indices | | | | | | | |
| 0 | 0 | 1 | 2 | 3 | 4 | 0 | 1 | 2 | 0 | 2 | 4 | 6 | 8 | 10 | 12 | 14 |
| 1 | 1 | 2 | 3 | 4 | 0 | 1 | 2 | 3 | 0 | 2 | 4 | 6 | 8 | 10 | 12 | 14 |
| 2 | 2 | 3 | 4 | 0 | 1 | 2 | 3 | 4 | 0 | 2 | 4 | 6 | 8 | 10 | 12 | 14 |
| 3 | 3 | 4 | 0 | 1 | 2 | 3 | 4 | 0 | 0 | 2 | 4 | 6 | 8 | 10 | 12 | 14 |
| 4 | 4 | 0 | 1 | 2 | 3 | 4 | 0 | 1 | 0 | 2 | 4 | 6 | 8 | 10 | 12 | 14 |
| 5 | 0 | 1 | 2 | 3 | 4 | 0 | 1 | 2 | 1 | 3 | 5 | 7 | 9 | 11 | 13 | 15 |
| 6 | 1 | 2 | 3 | 4 | 0 | 1 | 2 | 3 | 1 | 3 | 5 | 7 | 9 | 11 | 13 | 15 |
| 7 | 2 | 3 | 4 | 0 | 1 | 2 | 3 | 4 | 1 | 3 | 5 | 7 | 9 | 11 | 13 | 15 |
| 8 | 3 | 4 | 0 | 1 | 2 | 3 | 4 | 0 | 1 | 3 | 5 | 7 | 9 | 11 | 13 | 15 |
| 9 | 4 | 0 | 1 | 2 | 3 | 4 | 0 | 1 | 1 | 3 | 5 | 7 | 9 | 11 | 13 | 15 |

The radio access node 12 may in some embodiments perform a method for allocating resources of a physical downlink control channel for transmission of control information to one or more wireless devices in a wireless communication network. The radio access node 12 may map the control information to ECCEs of the physical downlink control channel, wherein the ECCEs correspond to EREGs carrying the control information in a number of PRB pairs. The radio access node may map EREGs of a first ECCE and EREGs of a second ECCE to the PRB pairs, wherein the first and second ECCE have at least one PRB pair in common and at least one PRB pair which is not in common.

The radio access node 12 may in some embodiments perform a method for allocating resources of a physical downlink control channel for transmission of control information to one or more wireless devices in a wireless communication network. The radio access node 12 may map the control information to ECCEs of the physical downlink control channel, wherein the ECCEs correspond to EREGs carrying the control information in a number of PRB pairs. The number of PRB pairs is different from an integer multiple of the number of EREGs of one ECCE, and the radio access node 12 may map a first number of EREGs to a first PRB pair and a second number of EREGs to a second PRB pair, wherein the first number of EREGs differ from the second number of EREGs.

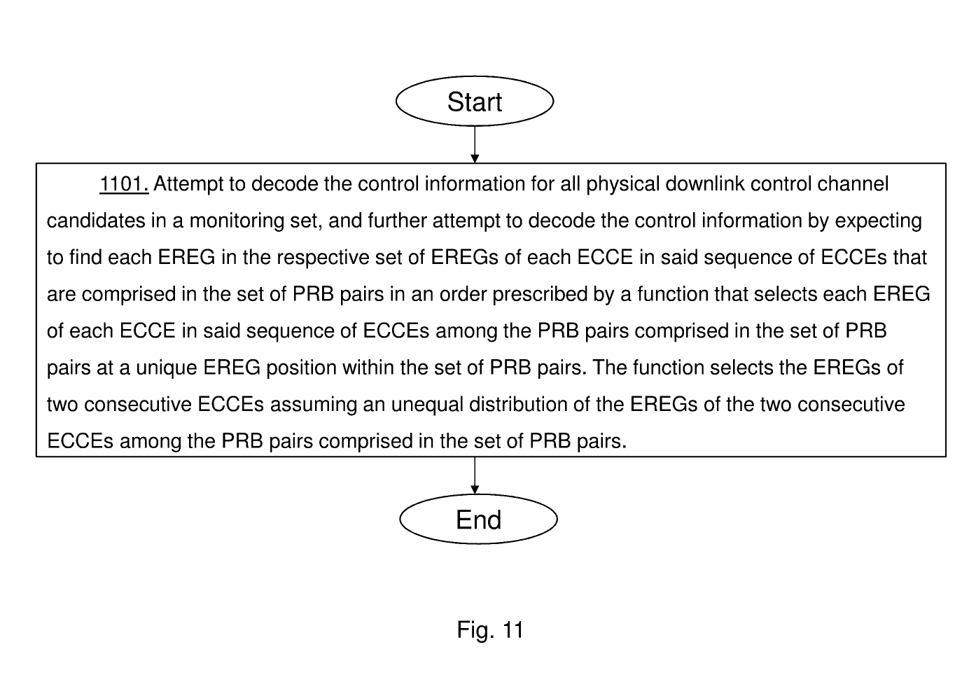

The method actions in the wireless device 10 for enabling reception at the wireless device 10 of control information carried over resources of one or more physical downlink control channels from the radio access node 12 in the wireless communication network 1 according to some embodiments will now be described with reference to a flowchart depicted in FIG. 11.

Action 1101. The wireless device 10 attempts to decode the control information for all physical downlink control channel candidates in a monitoring set, according to a monitored downlink control information format, where. Each physical downlink control channel candidate comprises a sequence of ECCEs of the one or more physical downlink control channels in a set of PRB pairs comprising a number of PRB pairs, wherein each ECCE in said sequence of ECCEs corresponds to a respective set of EREGs. The wireless device 10 further attempts to decode the control information by expecting to find each EREG in the respective set of EREGs of each ECCE in said sequence of ECCEs that are comprised in the set of PRB pairs in an order prescribed by a function that selects each EREG of each ECCE in said sequence of ECCEs among the PRB pairs comprised in the set of PRB pairs at a unique EREG position within the set of PRB pairs. The function selects the EREGs of two consecutive ECCEs assuming an unequal distribution of the EREGs of the two consecutive ECCEs among the PRB pairs comprised in the set of PRB pairs. One or more ECCEs belonging to each physical downlink control channel candidate may in some embodiments be determined or given by a search space equation. The function according to which the EREGs are selected in the wireless device 10 may be the same function as used by the radio access node 12 for distributing the EREGs, as described above.

Each respective set of EREGs may comprise a number of EREGs that differs from being the same or an integer multiple of the number of PRB pairs of the set of PRBs and vice versa. That is, the number of PRB pairs of the set of PRBs differs from being the same or an integer multiple of the number of EREGs of each respective set of EREGs. Each ECCE of the sequence of ECCEs uses a unique set of EREGs of the PRB pairs. Hence, each ECCE uses a unique set of resource elements of the PRB pairs.

The wireless device 10 may select the EREGs of the two consecutive ECCEs to PRB pairs in the set of PRB pairs taken in a cyclic order, whereby the EREGs of one of the two consecutive ECCEs are selected, in e.g. consecutive order, starting from a first PRB pair and the EREGs of the other one of the two consecutive ECCEs are selected, e.g. in consecutive order, starting from a next PRB pair in the cyclic order of PRB pairs in the set of PRB pairs. The wireless device 10 may thus select an initial EREG of a first ECCE from a first PRB pair and select an initial EREG of a second ECCE from a different PRB pair. The PRB pair different from the first PRB pair may or may not be contiguous to the first PRB pair. The wireless device 10 may thus select the EREGs of the ECCEs in said sequence of ECCEs from PRB pairs in the set of PRB pairs taken in a cyclic order, whereby EREGs of the respective set of EREGs of a first ECCE are selected, e.g. in consecutive order, starting from a first PRB pair and EREGs of the respective set of EREGs of a next ECCE are selected, e.g. in consecutive order, starting from a next PRB pair in the cyclic order of PRB pairs in the set of PRB pairs. The number of PRB pairs of the set of PRB pairs may be 3, 5, or 6.

The wireless device 10 may select each EREG of each ECCE in said sequence of ECCEs from a respective PRB pair corresponding to a respective PRB index, each respective PRB index being derived using a floor function and/or a ceil function of the number of PRB pairs in the set of PRB pairs divided by the number of EREGs comprised in each respective set of EREGs. Thus, the wireless device 10 may map an EREG of an ECCE to a PRB pair corresponding to a PRB index, which PRB index is derived with the function being a floor function and/or a ceil function based on a quotient between the number of the PRB pairs and the number of EREGs. The quotient may differ from being an integer and differ from the value 0.5.

The floor function may be used in determining each respective PRB index according to

$$( n + j max ( 1 , ⌊ {N}_{RB}^{{X}_{m}} / {N}_{EREG}^{ECCE} ⌋ ) ) mod {N}_{RB}^{{X}_{m}} ,$$

wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}ₘ being a number of PRB pairs of each set of PRB pairs.

The ceil function may be used in determining each respective PRB index according to

$$( n + j max ( 1 , ⌈ {N}_{RB}^{{X}_{m}} / {N}_{EREG}^{ECCE} ⌉ ) ) mod {N}_{RB}^{{X}_{m}} ,$$

using notations as specified above.

The function may further select EREGs of all ECCEs of the sequence of ECCE, or a number of ECCEs being an integer multiple of the number of PRB pairs, such that an equal and non-overlapping selection of EREGs among the number PRB pairs comprised in the set of PRB pairs is made.

A bandwidth allocated for the wireless device 10 in a subframe may comprise 6 consecutive PRBs in downlink within the wireless communication network 1.

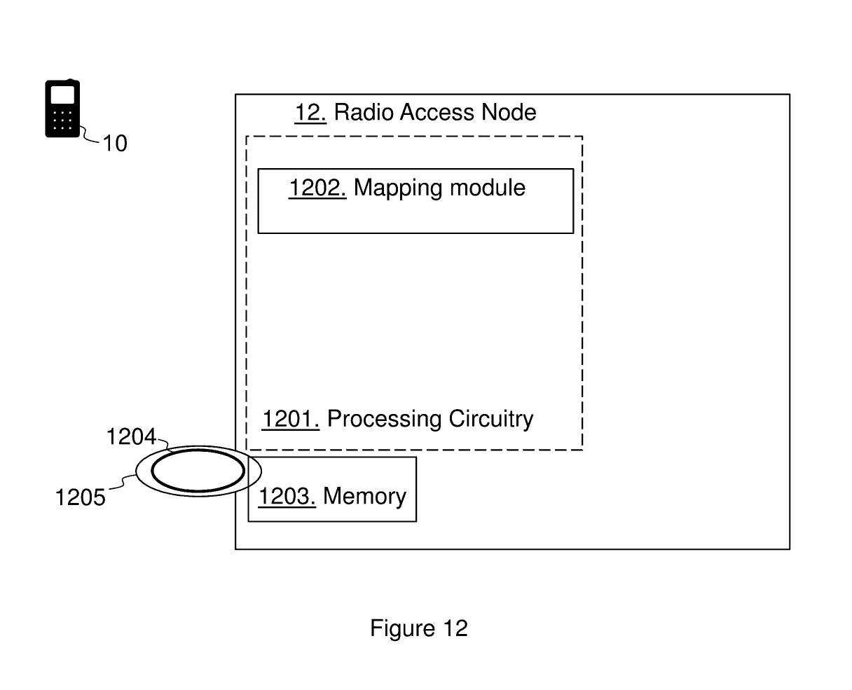

To perform the methods herein a radio access node 12 is provided. FIG. 12 is a block diagram depicting the radio access node 12 according to embodiments herein, for allocating resources of one or more physical downlink control channels for transmission of control information to one or more wireless devices in the wireless communication network 1. The radio access node 12 is configured to map the control information to a sequence of ECCEs of the one or more physical downlink control channels in a set of PRB pairs comprising a number of PRB pairs. Each ECCE in said sequence of ECCEs corresponds to a respective set of EREGs. The radio access node 12 is further configured to map each EREG in the respective set of EREGs of each ECCE in said sequence of ECCEs to the set of PRB pairs according to a function that distributes each EREG of each ECCE in said sequence of ECCEs among the PRB pairs comprised in the set of PRB pairs to a unique EREG position within the set of PRB pairs. The function distributes the EREGs of two consecutive ECCEs such that an unequal distribution of the EREGs of the two consecutive ECCEs among the PRB pairs comprised in the set of PRB pairs is obtained.

Each respective set of EREGs may comprise a number of EREGs that differs from being the same or an integer multiple of the number of PRB pairs of the set of PRBs and vice versa. The radio access node 12 may further be configured to map the EREGs of the two consecutive ECCEs to PRB pairs in the set of PRB pairs taken in a cyclic order, whereby the EREGs of one of the two consecutive ECCEs are mapped starting from a first PRB pair and the EREGs of the other one of the two consecutive ECCEs are mapped starting from a next PRB pair in the cyclic order of PRB pairs in the set of PRB pairs. The radio access node 12 may further be configured to map each EREG of each ECCE in said sequence of ECCEs to a respective PRB pair corresponding to a respective PRB index, and the radio access node may further be configured to derive each respective PRB index using a floor function and/or a ceil function of the number of PRB pairs in the set of PRB pairs divided by the number of EREGs comprised in each respective set of EREGs. The floor function may be used in determining each respective PRB index according to

$$( n + j max ( 1 , ⌊ {N}_{RB}^{{X}_{m}} / {N}_{EREG}^{ECCE} ⌋ ) ) mod {N}_{RB}^{{X}_{m}}$$

wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

The ceil function may be used in determining each respective PRB index according to

$$( n + j max ( 1 , ⌈ {N}_{RB}^{{X}_{m}} / {N}_{EREG}^{ECCE} ⌉ ) ) mod {N}_{RB}^{{X}_{m}}$$

wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

The number of PRB pairs of the set of PRB pairs may be 3, 5, or 6. In some embodiments a bandwidth allocated for the one or more wireless devices in a subframe comprises 6 consecutive PRBs in downlink within the wireless communication network.

The radio access node 12 may comprise processing circuitry 1201 to perform the methods herein.

The radio access node 12 may comprise a mapping module 1202. The processing circuitry 1201 and/or the mapping module 1202 may be configured to map the control information to the sequence of ECCEs of the one or more physical downlink control channels in the set of PRB pairs comprising the number of PRB pairs. Each ECCE in said sequence of ECCEs corresponds to the respective set of EREGs. The processing circuitry 1201 and/or the mapping module 1202 may further be configured to map each EREG in the respective set of EREGs of each ECCE in said sequence of ECCEs to the set of PRB pairs according to a function that distributes each EREG of each ECCE in said sequence of ECCEs among the PRB pairs comprised in the set of PRB pairs to a unique EREG position within the set of PRB pairs. The function distributes the EREGs of two consecutive ECCEs such that an unequal distribution of the EREGs of the two consecutive ECCEs among the PRB pairs comprised in the set of PRB pairs is obtained.

Each respective set of EREGs may comprise a number of EREGs that differs from being the same or an integer multiple of the number of PRB pairs of the set of PRBs and vice versa. The processing circuitry 1201 and/or the mapping module 1202 may further be configured to map the EREGs of the two consecutive ECCEs to PRB pairs in the set of PRB pairs taken in a cyclic order, whereby the EREGs of one of the two consecutive ECCEs are mapped starting from a first PRB pair and the EREGs of the other one of the two consecutive ECCEs are mapped starting from a next PRB pair in the cyclic order of PRB pairs in the set of PRB pairs.

The processing circuitry 1201 and/or the mapping module 1202 may be configured to map each EREG of each ECCE in said sequence of ECCEs to a respective PRB pair corresponding to a respective PRB index, and the processing circuitry 1201 and/or the mapping module 1202 may further be configured to derive each respective PRB index using a floor function and/or a ceil function of the number of PRB pairs in the set of PRB pairs divided by the number of EREGs comprised in each respective set of EREGs. The floor function may be used in determining each respective PRB index according to

$$( n + j max ( 1 , ⌊ {N}_{RB}^{{X}_{m}} / {N}_{EREG}^{ECCE} ⌋ ) ) mod {N}_{RB}^{{X}_{m}}$$

wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

The ceil function may be used in determining each respective PRB index according to

$$( n + j max ( 1 , ⌈ {N}_{RB}^{{X}_{m}} / {N}_{EREG}^{ECCE} ⌉ ) ) mod {N}_{RB}^{{X}_{m}}$$

wherein
n being an ECCE index, n=0, 1, . . . , N_{ECCE,m,k}−1
j being an index for EREGs of an ECCE, j=0,1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

The radio access node 12 further comprises a memory 1203. The memory 1203 comprises one or more units to be used to store data on, such as PRB indices, ECCE indices, mapping algorithms/functions, parameters, applications to perform the methods disclosed herein when being executed, and similar.

The methods according to the embodiments described herein for the radio access node 12 may respectively be implemented by means of e.g. a computer program 1204 or a computer program product, comprising instructions, i.e., software code portions, which, when executed on at least one processor, cause the at least one processor to carry out the actions described herein, as performed by the radio access node 12. The computer program 1204 may be stored on a computer-readable storage medium 1205, e.g. a disc or similar. The computer-readable storage medium 1205, having stored thereon the computer program, may comprise the instructions which, when executed on at least one processor, cause the at least one processor to carry out the actions described herein, as performed by the radio access node 12. In some embodiments, the computer-readable storage medium may be a non-transitory computer-readable storage medium.

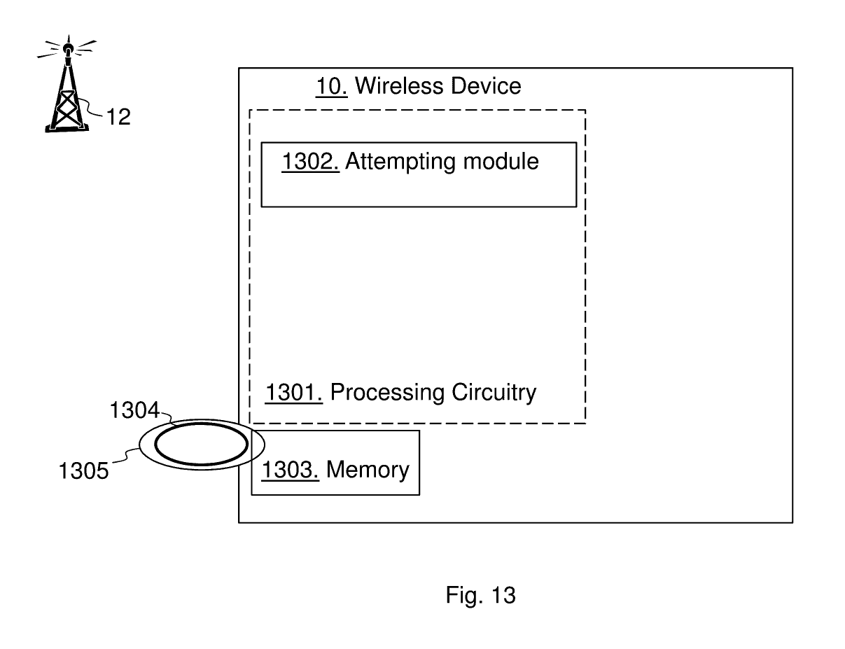

To perform the methods herein a wireless device is provided. FIG. 13 is a block diagram depicting the wireless device 10, according to embodiments herein, for enabling reception of control information carried over resources of one or more physical downlink control channels from the radio access node 12 in the wireless communication network 1. The wireless device 10 is configured to attempt to decode the control information for all physical downlink control channel candidates in a monitoring set, according to a monitored downlink control information format. Each physical downlink control channel candidate comprises a sequence of ECCEs of the one or more physical downlink control channels in a set of PRB pairs comprising a number of PRB pairs. The wireless device 10 is further configured to attempt to decode the control information by expecting to find each EREG in the respective set of EREGs of each ECCE in said sequence of ECCEs that are comprised in the set of PRB pairs in an order prescribed by a function that selects each EREG of each ECCE in said sequence of ECCEs among the PRB pairs comprised in the set of PRB pairs at a unique EREG position within the set of PRB pairs. The function selects the EREGs of two consecutive ECCEs assuming an unequal distribution of the EREGs of the two consecutive ECCEs among the PRB pairs comprised in the set of PRB pairs. The wireless device 10 may in some embodiments be configured to determine one or more ECCEs belonging to each physical downlink control channel candidate by using a search space equation. The function according to which the EREGs are selected in the wireless device 10 may be the same function as used by the radio access node 12 for distributing the EREGs, as described above.

Each respective set of EREGs may comprise a number of EREGs that differs from being the same or an integer multiple of the number of PRB pairs of the set of PRBs and vice versa. The wireless device 10 may further be configured to select the EREGs of the two consecutive ECCEs from PRB pairs in the set of PRB pairs taken in a cyclic order, whereby the EREGs of one of the two consecutive ECCEs are selected starting from a first PRB pair and the EREGs of the other one of the two consecutive ECCEs are selected starting from a next PRB pair in the cyclic order of PRB pairs in the set of PRB pairs. The wireless device 10 may further be configured to select each EREG of each ECCE in said sequence of ECCEs from a respective PRB pair corresponding to a respective PRB index, and the wireless device 10 may further be configured to derive each respective PRB index using a floor function and/or a ceil function of the number of PRB pairs in the set of PRB pairs divided by the number of EREGs comprised in each respective set of EREGs. The floor function may be used in determining each respective PRB index according to

$$( n + j max ( 1 , ⌊ {N}_{RB}^{{X}_{m}} / {N}_{EREG}^{ECCE} ⌋ ) ) mod {N}_{RB}^{{X}_{m}}$$

wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}ₘ being a number of PRB pairs of each set of PRB pairs.

The ceil function may be used in determining each respective PRB index according to

$$( n + j max ( 1 , ⌈ {N}_{RB}^{{X}_{m}} / {N}_{EREG}^{ECCE} ⌉ ) ) mod {N}_{RB}^{{X}_{m}}$$

wherein n being an ECCE index,
n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

The number of PRB pairs of the set of PRB pairs may be 3, 5, or 6. In some embodiments a bandwidth allocated for the wireless device 10 in a subframe comprises 6 consecutive PRBs in downlink within the wireless communication network 1.

The wireless device 10 may comprise processing circuitry 1301 configured to perform the methods herein.

The wireless device 10 may comprise an attempting module 1302. The processing circuitry 1301 and/or the attempting module 1302 may be configured to attempt to decode the control information for all physical downlink control channel candidates in a monitoring set, according to a monitored downlink control information format. Each physical downlink control channel candidate comprises a sequence of ECCEs of the one or more physical downlink control channels in a set of PRB pairs comprising a number of PRB pairs. The processing circuitry 1301 and/or the attempting module 1302 may further be configured to attempt to decode the control information by expecting to find each EREG in the respective set of EREGs of each ECCE in said sequence of ECCEs that are comprised in the set of PRB pairs in an order prescribed by a function that selects each EREG of each ECCE in said sequence of ECCEs among the PRB pairs comprised in the set of PRB pairs at a unique EREG position within the set of PRB pairs. The function selects the EREGs of two consecutive ECCEs assuming an unequal distribution of the EREGs of the two consecutive ECCEs among the PRB pairs comprised in the set of PRB pairs. The function according to which the EREGs are selected in the wireless device 10 may be the same function as used by the radio access node 12 for distributing the EREGs, as described above and one or more ECCEs belonging to each physical downlink control channel candidate may be given from a search space equation.

Each respective set of EREGs may comprise a number of EREGs that differs from being the same or an integer multiple of the number of PRB pairs of the set of PRBs and vice versa. The processing circuitry 1301 and/or the attempting module may further be configured to select the EREGs of the two consecutive ECCEs from PRB pairs in the set of PRB pairs taken in a cyclic order, whereby the EREGs of one of the two consecutive ECCEs are selected starting from a first PRB pair and the EREGs of the other one of the two consecutive ECCEs are selected starting from a next PRB pair in the cyclic order of PRB pairs in the set of PRB pairs.

The processing circuitry 1301 and/or the attempting module 1302 may be configured to select each EREG of each ECCE in said sequence of ECCEs from a respective PRB pair corresponding to a respective PRB index, and the processing circuitry 1301 and/or the attempting module 1302 may further be configured to derive each respective PRB index using a floor function and/or a ceil function of the number of PRB pairs in the set of PRB pairs divided by the number of EREGs comprised in each respective set of EREGs. The floor function may be used in determining each respective PRB index according to

$$( n + j max ( 1 , ⌊ {N}_{RB}^{{X}_{m}} / {N}_{EREG}^{ECCE} ⌋ ) ) mod {N}_{RB}^{{X}_{m}}$$

wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

The ceil function may be used in determining each respective PRB index according to

$$( n + j max ( 1 , ⌈ {N}_{RB}^{{X}_{m}} / {N}_{EREG}^{ECCE} ⌉ ) ) mod {N}_{RB}^{{X}_{m}}$$

wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

The wireless device 10 further comprises a memory 1303. The memory 1303 comprises one or more units to be used to store data on, such as search spaces, the function, reference signals, applications to perform the methods disclosed herein when being executed, and similar.

The methods according to the embodiments described herein for the wireless device 10 may respectively be implemented by means of e.g. a computer program 1304 or a computer program product, comprising instructions, i.e., software code portions, which, when executed on at least one processor, cause the at least one processor to carry out the actions described herein, as performed by the wireless device 10. The computer program 1304 may be stored on a computer-readable storage medium 1305, e.g. a disc or similar. The computer-readable storage medium 1305, having stored thereon the computer program, may comprise the instructions which, when executed on at least one processor, cause the at least one processor to carry out the actions described herein, as performed by the wireless device 10. In some embodiments, the computer-readable storage medium may be a non-transitory computer-readable storage medium.

It will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless terminal or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications receivers will appreciate the cost, performance, and maintenance tradeoffs inherent in these design choices.

It will be appreciated that the foregoing description and the accompanying drawings represent non-limiting examples of the methods and apparatuses taught herein. As such, the inventive apparatuses and techniques taught herein are not limited by the foregoing description and accompanying drawings. Instead, the embodiments herein are limited only by the following claims and their legal equivalents.

1-18. (canceled)

19. A method performed in a radio access node for allocating resources of one or more physical downlink control channels for transmission of control information to one or more wireless devices in a wireless communication network, the method comprising:
mapping the control information to a sequence of enhanced Control Channel Elements (ECCEs) of the one or more physical downlink control channels in a set of Physical Resource Block (PRB) pairs comprising a number of PRB pairs, wherein each enhanced Control Channel Element (ECCE) in said sequence of ECCEs corresponds to a respective set of enhanced Radio Element Groups (EREGs) and the mapping comprises mapping each enhanced Radio Element Group (EREG) in the respective set of EREGs of each ECCE in said sequence of ECCEs to the set of PRB pairs according to a function that distributes each EREG of each ECCE in said sequence of ECCEs among the PRB pairs comprised in the set of PRB pairs to a unique EREG position within the set of PRB pairs, wherein the function distributes the EREGs of two consecutive ECCEs such that an unequal distribution of the EREGs of the two consecutive ECCEs among the PRB pairs comprised in the set of PRB pairs is obtained.

20. The method of claim 19, wherein each respective set of EREGs comprises a number of EREGs that differs from being the same or an integer multiple of the number of PRB pairs of the set of PRBs and vice versa.

21. The method of claim 19, wherein the mapping comprises mapping the EREGs of the two consecutive ECCEs to PRB pairs in the set of PRB pairs taken in a cyclic order, such that the EREGs of one of the two consecutive ECCEs are mapped starting from a first PRB pair and the EREGs of the other one of the two consecutive ECCEs are mapped starting from a next PRB pair in the cyclic order of PRB pairs in the set of PRB pairs.

22. The method of claim 19, wherein the mapping comprises mapping each EREG of each ECCE in said sequence of ECCEs to a respective PRB pair corresponding to a respective PRB index, each respective PRB index being derived using a floor function and/or a ceil function of the number of PRB pairs in the set of PRB pairs divided by the number of EREGs comprised in each respective set of EREGs.

23. The method of claim 22, wherein the floor function is used in determining each respective PRB index according to
$$( n + j max ( 1 , ⌊ {N}_{RB}^{{X}_{m}} / {N}_{EREG}^{ECCE} ⌋ ) ) mod {N}_{RB}^{{X}_{m}}$$
wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

24. The method of claim 22, wherein the ceil function is used in determining each respective PRB index according to
$$( n + j max ( 1 , ⌈ {N}_{RB}^{{X}_{m}} / {N}_{EREG}^{ECCE} ⌉ ) ) mod {N}_{RB}^{{X}_{m}}$$
wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

25. The method of claim 19, wherein the number of PRB pairs of the set of PRB pairs is 3, 5, or 6.

26. The method of claim 19, wherein a bandwidth allocated for the one or more wireless devices in a subframe comprises 6 consecutive PRBs in downlink within the wireless communication network.

27. A method performed in a wireless device for enabling receiving control information carried over resources of one or more physical downlink control channels from a radio access node in a wireless communication network, the method comprising:
attempting to decode the control information for all physical downlink control channel candidates in a monitoring set, according to a monitored downlink control information format, wherein each physical downlink control channel candidate comprises a sequence of ECCEs of the one or more physical downlink control channels in a set of PRB pairs comprising a number of PRB pairs, wherein each ECCE in said sequence of ECCEs corresponds to a respective set of EREGs, and further attempting to decode the control information by expecting to find each EREG in the respective set of EREGs of each ECCE in said sequence of ECCEs that are comprised in the set of PRB pairs in an order prescribed by a function that selects each EREG of each ECCE in said sequence of ECCEs among the PRB pairs comprised in the set of PRB pairs at a unique EREG position within the set of PRB pairs, wherein the function selects the EREGs of two consecutive ECCEs assuming an unequal distribution of the EREGs of the two consecutive ECCEs among the PRB pairs comprised in the set of PRB pairs.

28. A radio access node for allocating resources of one or more physical downlink control channels for transmission of control information to one or more wireless devices in a wireless communication network, the radio access node comprising processing circuitry configured to:
map the control information to a sequence of enhanced Control Channel Elements (ECCEs) of the one or more physical downlink control channels in a set of Physical Resource Block (PRB) pairs comprising a number of PRB pairs, wherein each enhanced Control Channel Element (ECCE) in said sequence of ECCEs corresponds to a respective set of enhanced Radio Element Groups (EREGs) and further being configured to map each enhanced Radio Element Group (EREG) in the respective set of EREGs of each ECCE in said sequence of ECCEs to the set of PRB pairs according to a function that distributes each EREG of each ECCE in said sequence of ECCEs among the PRB pairs comprised in the set of PRB pairs to a unique EREG position within the set of PRB pairs, wherein the function distributes the EREGs of two consecutive ECCEs such that an unequal distribution of the EREGs of the two consecutive ECCEs among the PRB pairs comprised in the set of PRB pairs is obtained.

29. The radio access node of claim 28, wherein each respective set of EREGs comprises a number of EREGs that differs from being the same or an integer multiple of the number of PRB pairs of the set of PRBs and vice versa.

30. The radio access node of claim 28, wherein the processing circuitry is further configured to map the EREGs of the two consecutive ECCEs to PRB pairs in the set of PRB pairs taken in a cyclic order, whereby the EREGs of one of the two consecutive ECCEs are mapped starting from a first PRB pair and the EREGs of the other one of the two consecutive ECCEs are mapped starting from a next PRB pair in the cyclic order of PRB pairs in the set of PRB pairs.

31. The radio access node of claim 28, wherein the processing circuitry is further configured to map each EREG of each ECCE in said sequence of ECCEs to a respective PRB pair corresponding to a respective PRB index, further being configured to derive each respective PRB index using a floor function and/or a ceil function of the number of PRB pairs in the set of PRB pairs divided by the number of EREGs comprised in each respective set of EREGs.

32. The radio access node of claim 31, wherein the floor function is used in determining each respective PRB index according to
$$( n + j max ( 1 , ⌊ {N}_{RB}^{{X}_{m}} / {N}_{EREG}^{ECCE} ⌋ ) ) mod {N}_{RB}^{{X}_{m}}$$
wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

33. The radio access node of claim 31, wherein the ceil function is used in determining each respective PRB index according to
$$( n + j max ( 1 , ⌈ {N}_{RB}^{{X}_{m}} / {N}_{EREG}^{ECCE} ⌉ ) ) mod {N}_{RB}^{{X}_{m}}$$
wherein
n being an ECCE index, n=0, 1, . . . , N_{ECCE,m,k}−1
j being an index for EREGs of an ECCE, j=0, 1, . . . , N_{EREG}^{ECCE}−1
N_{ECCE,m,k} being the number of ECCEs in set Xₘ of subframe k
N_{EREG}^{ECCE} being a number of EREGs of each ECCE
N_{RB}^{X}^{ₘ} being a number of PRB pairs of each set of PRB pairs.

34. The radio access node of claim 28, wherein the number of PRB pairs of the set of PRB pairs is 3, 5, or 6.

35. The radio access node of claim 28, wherein a bandwidth allocated for the one or more wireless devices in a subframe comprises 6 consecutive PRBs in downlink within the wireless communication network.

36. A wireless device for enabling receiving control information carried over resources of one or more physical downlink control channels from a radio access node in a wireless communication network, the wireless device comprising processing circuitry configured to:
attempt to decode the control information to attempt to decode the control information for all physical downlink control channel candidates in a monitoring set, according to a monitored downlink control information format, wherein each physical downlink control channel candidate comprises a sequence of ECCEs of the one or more physical downlink control channels in a set of PRB pairs comprising a number of PRB pairs, wherein each ECCE in said sequence of ECCEs corresponds to a respective set of EREGs, and further being configured to decode the control information by expecting to find each EREG in the respective set of EREGs of each ECCE in said sequence of ECCEs that are comprised in the set of PRB pairs in an order prescribed by a function that selects each EREG of each ECCE in said sequence of ECCEs among the PRB pairs comprised in the set of PRB pairs at a unique EREG position within the set of PRB pairs, wherein the function selects the EREGs of two consecutive ECCEs assuming an unequal distribution of the EREGs of the two consecutive ECCEs among the PRB pairs comprised in the set of PRB pairs.
